(19) United States
(12) Patent Application Publication
(10) Pub. No.: US 2016/0379175 A1
(43) Pub. Date: Dec. 29, 2016

(54) System and Method for Automated Optimized Personal Task Scheduling and Targeted Advertising

(71) Applicants: Mayukh Bhattacharya, Palo Alto, CA (US); Michal Jerzy Rewienski, Gdansk (PL); Soummya Kar, Pittsburgh, PA (US); Udita Bhattacharya, Palo Alto, CA (US)

(72) Inventors: Mayukh Bhattacharya, Palo Alto, CA (US); Michal Jerzy Rewienski, Gdansk (PL); Soummya Kar, Pittsburgh, PA (US); Udita Bhattacharya, Palo Alto, CA (US)

(73) Assignees: Mayukh Bhattacharya, Palo Alto, CA (US); Soummya Kar, Pittsburgh, PA (US); Michal Jerzy Rewienski, Gdansk, OT (PL)

(21) Appl. No.: 14/748,224

(22) Filed: Jun. 23, 2015

(51) Int. Cl. G06Q 10/10

(52) U.S. Cl. CPC G06Q 10/1097

(57) ABSTRACT

The present invention describes mobile phone applications that include methods and systems which automatically schedule tasks from a dynamically-changing task list for efficient utilization of available time. Unlike the prior personal task scheduling systems, the proposed system uses optimization algorithms and computer programs when creating a time schedule of tasks. In order to schedule individual tasks, the system takes into account multiple constraints controllable by the user. Basic constraints include individual task's deadline, start-time, minimum and maximum time-chunks for task fragments, relative priority of tasks (in case of time-collision), etc. Further constraints may include user's general preferences regarding individual task or group of tasks. Specifically, preferences may include time-of-day (e.g., morning, evening), location (e.g., home, work, particular grocery store or chain, particular gym, park), etc. In order to schedule the tasks, the system considers the user's calendar information and regards scheduled time-slots in the calendar as unavailable time for task scheduling. The system also considers as unavailable user-defined time periods reserved for such activities as sleeping, eating, resting, etc., unless the task specifically involves such activities. Furthermore, the system is flexible in the sense that the user can choose not to follow the advised task schedule and reprioritize tasks at his/her will. The system contains other interactive features such as issuing various task alerts to the user, allows the user to decline/delegate tasks and visualization (e.g. based on color coding) of the task-list (based on the status of the tasks, for example, close to completion, cannot be delegated etc.). The allocation is adaptive, in that, the schedule is automatically updated as new tasks enter the system, after task completions, when task priorities are modified, and based on other user inputs such as task declining/delegation. Finally, the system can be operated in a networked mode in which joint tasks involving multiple users (and their calendars) can be scheduled. Since the system will store the calendared event times of each user in the server, a joint task among multiple users can be scheduled based on the superimposed calendars of the users while protecting privacy of individual user's calendars.

### CROSS-REFERENCE TO RELATED APPLICATIONS

Not Applicable

### STATEMENT REGARDING FEDERALLY-SPONSORED RESEARCH AND DEVELOPMENT

Not Applicable

### FIELD OF THE INVENTION

This invention relates to the field of personal task-list management via a mobile smartphone application. Specifically, this invention relates to an automatically optimized time allocation for a dynamically-changing list of tasks taking into account the task-owner's inputs pertaining to the urgency, periodicity, estimated man-hours, perceived difficulty and variety of preferences (such as preferable location, time-of-day, day-of-week). The system also considers the user's latest unavailable-time information (gathered from calendars and other user-provided data) to find available time slots for scheduling tasks from user's task list. Unlike the prior art in this field, which largely requires the user to specify the time slot to perform the task (ie. is mostly based on ‘manual’ or ‘semi-manual’ scheduling), the presented system performs automated task scheduling, yielding optimized personal task schedule which meets the specified requirements and preferences. The elements of the automated task optimization system are placed both within the smartphone application, as well as within the supporting server infrastructure. The system contains various interactive features such as issuing task alerts to the user, allows user declining/delegation of tasks, or selecting from a few suggested tasks, and visualization (e.g. color coding) of the task-list (based on the status of the tasks, for example, close to completion, cannot be delegated etc.). The allocation is adaptive, in that, the scheduling is automatically updated as new tasks enter the system, after task completions, when task priorities are modified, and based on other user inputs such as task declining/delegation. Finally, the system can be operated in a networked mode in which joint tasks involving multiple users (and their calendars) can be scheduled.

If the user's pending task involves purchasing any goods or services, discounts from relevant merchants and businesses can be offered to the user based on their location and other preferences.

For example, if a user's task item mentions “workout” and the location service tells us which particular gym location the user commonly uses, then discounts or other incentives could be offered to the user either from the same gym or from other gyms at nearby locations. Similar offerings can be made for groceries and miscellaneous shopping items.

### BACKGROUND OF THE INVENTION

The ease of internet access along with the affordability of mobile communication systems has led to unprecedented increase in interpersonal communication. Furthermore, message broadcasting capabilities of social-networking media have made one-to-many and many-to-one communication cheap and fast. All these have made our social lives (at least in the virtual sense) quite full, but at the same time have adversely affected our available time for performing real work. It is well-understood that true-multitasking is a myth and real focus is an absolute necessity in maintaining high-quality productivity [1] in any arena—whether work, life, art, or sport. In this context, effective and optimal personal time management has become more important than ever before in order to lead a balanced life.

The present invention makes use of the mobile smartphone device, supported by the cloud computing infrastructure, to allow best use of time to accomplish our pending tasks.

### BRIEF SUMMARY OF THE INVENTION

The present invention describes mobile phone applications that include methods and systems which automatically schedule tasks from a dynamically-changing task list for efficient utilization of available time. Unlike the prior personal task scheduling systems, the proposed system uses optimization algorithms and computer programs when creating a time schedule of tasks. In order to schedule individual tasks, the system takes into account multiple constraints controllable by the user. Basic constraints include individual task's deadline, start-time, minimum and maximum time-chunks for task fragments, relative priority of tasks (in case of time-collision), etc. Further constraints may include user's general preferences regarding individual task or group of tasks. Specifically, preferences may include time-of-day (e.g., morning, evening), location (e.g., home, work, particular grocery store or chain, particular gym, park), etc. In order to schedule the tasks, the system considers the user's calendar information and regards scheduled time-slots in the calendar as unavailable time for task scheduling. The system also considers as unavailable user-defined time periods reserved for such activities as sleeping, eating, resting, etc., unless the task specifically involves such activities. Furthermore, the system is flexible in the sense that the user can choose not to follow the advised task schedule and reprioritize tasks at his/her will. The system contains other interactive features such as issuing various task alerts to the user, allows user declining/delegation of tasks and visualization (e.g. based on color coding) of the task-list (based on the status of the tasks, for example, close to completion, cannot be delegated etc.). The allocation is adaptive, in that, the schedule is automatically updated as new tasks enter the system, after task completions, when task priorities are modified, and based on other user inputs such as task declining/delegation. Finally, the system can be operated in a networked mode in which joint tasks involving multiple users (and their calendars) can be scheduled. Since the system will store the calendared event times of each user in the server, a joint task among multiple users can be scheduled based on the superimposed calendars of the users while protecting privacy of individual user's calendars.

### BRIEF DESCRIPTION OF THE FIGURES

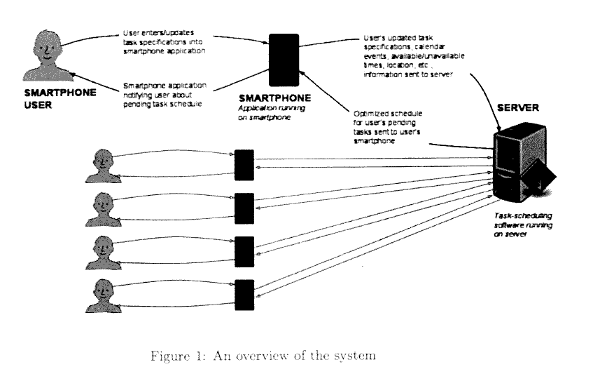

1. FIG. 1 is a schematic drawing showing overview of the system.

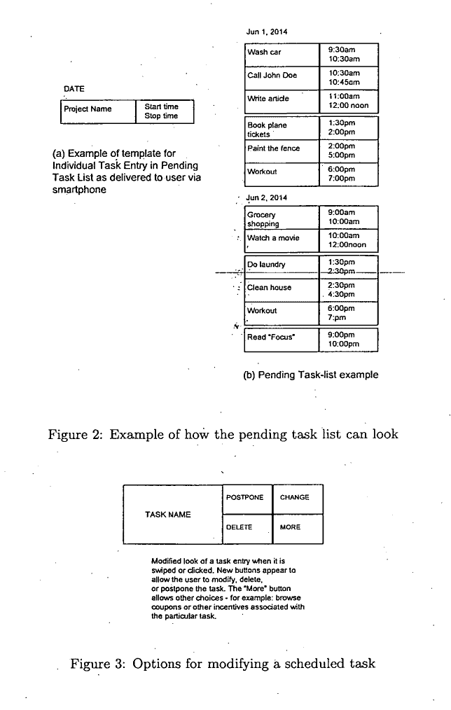

2. FIG. 2 is a schematic drawing illustrating a typical pending task-list visualization.

3. FIG. 3 is a schematic drawing illustrating the detailed visualization of an individual task with various options for editing or modifying and is obtained by swiping or clicking the entry corresponding to the task on the pending task visualization list in FIG. 2.

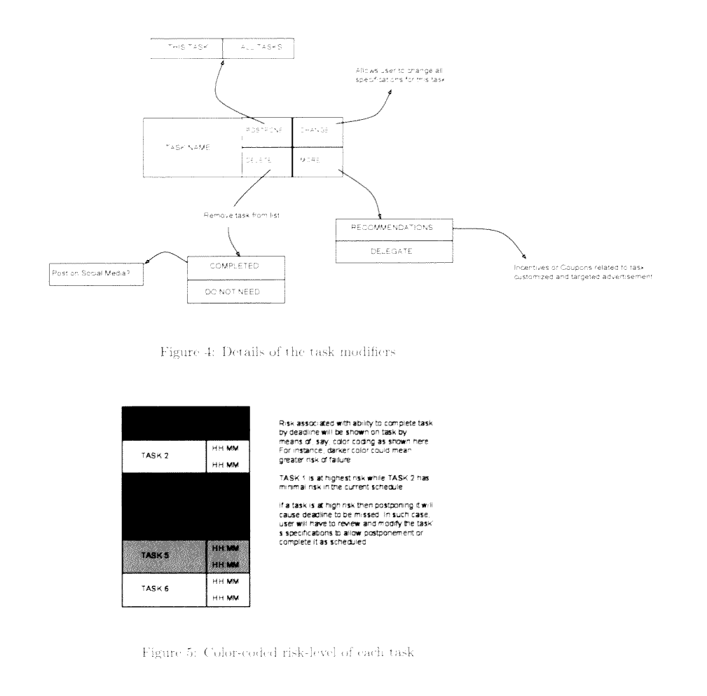

4. FIG. 4 is a schematic drawing illustrating the task editing feature of the system such as modifying the task specifics, removing the task from the list, delegating, postponing, viewing/accepting incentives and coupons related to the task and other socio-economic aspects of the task.

5. FIG. 5 is a schematic drawing illustrating the color-coded task-list visualization delineating the status and risk-levels associated with the individual tasks, for instance, how close is the task to completion, whether the task can be postponed without missing the deadline etc.

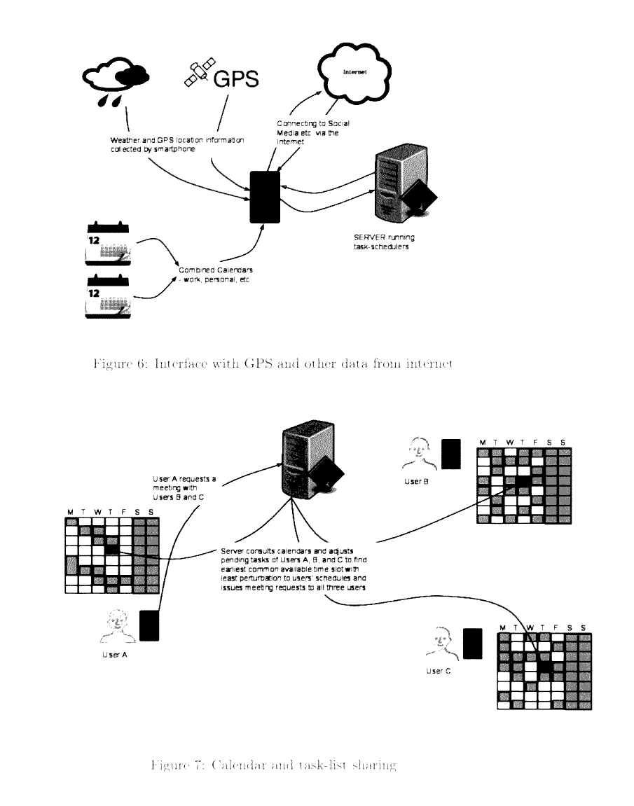

6. FIG. 6 is a schematic drawing showing how the application interfaces with GPS and internet data which are used as inputs in the allocation process.

7. FIG. 7 is a schematic drawing demonstrating calendar and task-list sharing among multiple users and networking aspects of the application.

### DETAILED DESCRIPTION OF THE INVENTION

To assist in describing the present invention, an explanation of the problem formulation is first provided.

### 9.1 PROBLEM FORMULATION

The present invention addresses the problem of personal task scheduling (or task scheduling from a to-do-list) by means of a mobile phone application. At any time, a task-list may include many individual tasks and the list may change frequently as some tasks get done or new tasks get added to it, or various attributes of existing tasks are modified. The attributes of each task can include such things as estimated time-effort (or estimated man-hours), start-time, stop-time (deadline), perceived difficulty (or required focus level), importance or priority level, minimum-size of subtask time, maximum-size of subtask time, preferred day-of-week, preferred time-of-day, task recurrence (e.g. weekly or monthly), preferred location (home, work, gym, store, park, car, etc.). The available time for scheduling tasks from the list is any time excluding the time periods that are blocked out in the calendar, and other times allocated for resting, sleeping, eating, etc. All the above information is used by optimization algorithms and programs within the proposed system in order to automatically create an efficient task schedule. The present invention has several interactive and flexible task scheduling features: (a-i) the system can issue alerts through various user notifications about task schedules, changes in priority and status messages as to whether a task is near completion, the deadline is approaching, if a task can no longer be delegated or rescheduled to a future date, and if a certain pending task (possibly of lower priority) needs to be dropped to meet the deadlines of other tasks; (a-ii) the user has the provision to decline or delegate a task in which case based on the user's input either the task is rescheduled to a later date or dropped from the list; and (a-iii) color-coded visualization of the task-list illustrating the task timelines, their status and other task prioritization information. In addition to using direct user entered input for updating task schedules, the present invention uses other forms of data such as (b-i) locational, weather etc. for instance, from the smartphone GPS, by connecting to the Internet, and various other contextual task-related information; (b-ii) calendars and task-lists of other users that are shared or partially shared (in the case if a task is to be performed jointly by multiple users), for updating/reallocating the tasks. The present allocation method is adaptive, in that, the task schedules are automatically updated each time a new task is entered, a task gets completed, the application interacts with the user in modes (a-i)-(a-iii) as listed above, or obtains task related information as outlined in (b-i)-(b-ii).

In this section, we describe the invented system in detail.

### 9.2 OVERVIEW OF THE INVENTION

The system comprises of
1. A mobile smartphone with a calendar application and GPS (also needs to access local current weather and weather forecast—but don't need extra application for that—app can directly access weather website).
2. A server which accepts and saves user's task-list data and which runs optimization algorithms for scheduling tasks from the list.
3. A mobile smartphone application (running on the aforementioned smart-phone) that has the ability to accept user's task description as input. The application also has the ability to present to the user (e.g., in a scrollable list format) about up-coming tasks—for a variety of time-horizons (current day, next several days, up-coming month, etc.). The application has access to user's calendar and GPS system (pre-installed in the smart-phone). The application acts as the interface between the aforementioned server and the phone's user. The application may also be able to access a third-party application that the user may use to store his/her pending tasks. Further, whenever new task-related information is available such as in the form of GPS or internet data, or the user provides inputs such as delegating/declining/postponing tasks, the application interacts with the server to modify/reallocate the tasks accordingly. The application may also be able to operate in a networked mode in which multiple users can coordinate either directly or through the server to schedule joint tasks.
4. A number of different algorithms (employing diverse optimization methodologies such as linear programming [3], integer programming [4], graph-based algorithms [5, 6] etc.) for task scheduling with calendar event and other aforementioned constraints (e.g., urgency, deadline, location preferences, etc.). Some of the algorithms are heuristic-based and fast. Some of the algorithms are slower (computationally more expensive) and can achieve closer-to-optimal scheduling. Faster algorithms are implemented on the smartphone application and run on the smartphone processor. The slower algorithms are implemented on the server. When a user modifies tasks or calendar events and needs a quick rescheduling of immediate task sequence, one or more of the algorithms on the phone can provide a new task sequence. Algorithms on the server can then work on the new data in background to generate a closer-to-optimal task sequence. This latter process, being slower, can be scheduled to occur on the server during user's calendar block time, or when the user is detected to be driving (detected by rapid location change detection) or is otherwise detected to be occupied.

### 9.3 THE SERVER

### Features:

1. Sufficient memory to store user's task information.
2. Contains updated data regarding:
   User's general preferences regarding task execution (referred to henceforth as default constraints).
   User's latest pending task list with complete constraint description (referred henceforth as task-specific constraints).
   User's latest calendared blocked times.
   User's non-calendared blocked times (e.g., rest/sleep/eating times).
3. Software for scheduling tasks (in an optimized manner) from the pending task list into the available non-blocked times taking into account user's default and specific constraints.
4. Software for continuously and adaptively modifying user's task schedule as and when the user obtains new task-related information (such as GPS or internet data) and in response to various other user inputs such as task delegation/declining/postponing.
5. Software for scheduling joint tasks across multiple users (with different calendars) when a joint task request is initiated.

### 9.4 THE MOBILE SMART-PHONE

### Features:

1. Should have ability to connect to internet.
2. Must run the aforementioned application.
3. Preferably stores or has access to user's combined calendar or calendars (e.g., home, work, etc.).
4. Have GPS/Location service enabled—if user wants to have location constraints in his/her tasks.

### 9.5 THE APPLICATION

### 9.5.1 Setup Phase

### Fundamental Setup—User Account Registration

In the setup phase, the application will request the user to open an account based on email address and password, or facebook or other social-media login identification, etc.

The rest of the setup phase is optional and can be changed by user at any given time.

### Default or General Preference Setup (During First-Time Use)

This section describes the required steps during the initial use of the application. The application will request the user for calendar access and location data access.

Further, it will request the user for some general preferences to be setup which can be overridden later on a per-task basis.

Further, it will ask the user about general preferences and non-calendared event times—e.g., usual sleeping time periods and other do-not-disturb periods (resting, eating, etc.).

Further, it will ask the user about preferred minimum-time effort for long tasks—say, user wants to work at least 30 minutes on each task before moving on to another task (so called Pomodoro or Tomato method [2]).

Further, it will ask the user about preferred buffer time between tasks (preparation time or recovery time). For example, in the Pomodoro/Tomato method, 5-10 minutes of rest is recommended between tasks.

Further, it will ask the user if he/she would want a will-reply-later mode for text-messages or phone calls received during busy periods.

Further it may ask the user how many tasks per day it is allowed to schedule, provided the resulting schedule is feasible, i.e. meets all the constraints.

The application registers user's account with the server and saves the permissions and default preferences (all encrypted).

### 9.5.2 Normal Operation Phase

Once setup is accomplished, the application will begin its normal operation. In this phase, the user will be able to enter pending task list as and when he/she chooses to. For each task, he/she will be allowed to enter task-specific constraints, some of which are mentioned below:
1. Start time: A date/time before which the user does not wish to begin the task.
2. Stop time: A date/time before which the user wants to complete the task. Can also be referred to as task deadline.
3. Recurrence of the task (e.g. weekly, monthly): Specifies if the task has a recurring (periodic) character.
4. Estimated total time-effort: User's a-priori estimation of how much total time-effort is needed for the whole task. (Optionally the application may suggest the time-effort required to complete the task based on the times actually spent on the previously completed tasks.)
5. Preferred location of the task. For example: work, home, grocery store, anywhere, etc.
6. Minimum time slice: Minimum amount of time user wants to spend on the task each time he works on the task—if this is different from his/her default constraint.
7. Maximum time slice: Maximum amount of time user wants to spend on the task each time he works on the task—if this is different from his/her default constraint.
8. Preferred days of the week: In case user has a preference about which days of the week he wants to work on the task. E.g., weekdays only, T, Th, Su, etc.
9. Preferred time of the day: In case user has a preference about what time of the day he wants to Work on the task—morning, afternoon, evening, night, etc.
10. Preferred weather condition: In case user has a preference about the weather condition at the time of performing the task.
11. Preferred preparation time: If the user needs some time for rest or travel-to-destination or for mental-preparation or for collecting task materials, etc. If this is different from his/her default constraint. E.g., user does not want to waste buffer time and is mentally in a “flow” state.
12. Preferred recovery time: If the user needs some time for rest after a task before moving on to another task. If this is different from his/her default constraint.

For periodic (recurring) tasks: one may also enter minimum and maximum time between consecutive events, as well as the last time the task was performed (e.g. date of the last haircut).

User can change his/her task-specific contraints and preferences and general/default constraints and preferences at any time. For example if he/she had underestimated or overestimated the required time-effort for a particular task in the a-priori estimation, then he/she can modify the time-effort dynamically. Optionally, the system will suggest or adjust the specified time effort (or the default time effort) for a particular task, based on the times (measured and stored by the application) actually spent on the previously completed tasks.

The user-defined tasks are updated in the application's local memory in the smartphone and then sent to the server to be saved under the user's account data.

### 9.5.3 Consultation Phase

Interactively inform about infeasibility. Enter into consultation mode. Based on current task-list and constraints, the system determines that not all tasks can be accomplished by satisfying all constraints or it is unable to find a schedule which will satisfy all the constraints.

In this phase, an algorithm for constraint relaxation is applied. Different scenarios are considered:
Rest times are reduced by 10%
Weather constraints are relaxed
Location constraints are relaxed (may have to bring home some work)
Time-of-day constraints are relaxed
Buffer constraints are relaxed
The system suggests to reschedule or remove certain activities from the calendar which prevent timely completion of the tasks.
Hard-work phase is introduced (based on user's history of certain type of work)
The system asks whether some or all task deadlines can be ignored and subsequently finds an optimal schedule. Tasks scheduled beyond their original deadlines are flagged.

In each case, the app asks the user whether some constraint relaxation can be tried—do you want to consider relaxing some rest time for the next 20 days?

### 9.5.4 Task Suggestion or Push Phase

Every morning, an updated task list is ready for the user to peruse.

The user has total freedom of modifying any constraint of any task and can even dismiss/delegate some task.

The application may limit the number of task scheduled to be completed in a single day to a prespecified number of tasks (defaults may be set), if it is feasible. The application may increase or reduced the number of tasks scheduled per day, based on user's previous performance or preferences.

Any time the user's blocked times (calendared or otherwise) are modified, or his/her task-list has been modified or his/her task-constraints have been modified, the scheduling algorithm running on the server will be triggered to work on the revised pending task list and latest blocked time segments to produce a new task schedule.

The new task list is sent to the smartphone application where the user can peruse it by a scrollable, clickable list and the next immediate task is brought to the user's attention by means of the smartphone's “notification” mechanism.

Once the user clicks on the notification, he is given information regarding the task—its stop-time, “auto-reply” of phone messages and text messages, etc (if default values need to be overridden).

### 9.5.5 Periodic Analysis

General advice on achievability of pending tasks based on the current constraints—if you are willing to relax this particular constraint, you can significantly improve your chances of meeting deadline for a particular task.

Suggest dropping/delegating. The application may open email application with a pre-defined task template that the user can direct towards someone to delegate a task.

### 9.5.6 Joint Task Allocation and User Coordination

For scheduling joint tasks across multiple users (refer to FIG. 7), the server coordinates and performs joint optimization on the individual users' schedules. For instance, a joint task request could be initiated by a single user which requires simultaneous participation of several other users (such as conferencing or a group of friends interested in watching a movie together). Further, other task specifications such as whether the users need to be co-located geographically or virtually etc., may be provided. Flexible dates could be specified for the joint task, e.g. no earlier that one week and no later than two weeks from the current date. In this case, based on the users' calendars and task lists, the server tries to obtain a common slot in their schedules by jointly optimizing over the calendars and task-lists. Moreover, the scheduling is adaptive, in that, if one of the participants decides to drop-out/decline/postpone, notifications are sent out to the other users and the joint task is rescheduled or modified appropriately. Yet another form of joint task involving multiple users could be scheduled in which not all users need to participate simultaneously, however, at least one (or more but not all, according to the task specifics) should be able to allocate time to execute the task. For instance, if the task consists of taking the kid(s) to school, either mom or dad (at least one but not necessarily both) should be able to perform. In this scenario, the software considers the calendars and task-lists of all the users who agree to participate and based on feasibility and other optimality criteria allocates to one of the users. Moreover, the scheduling is adaptive, in that, the allocation may be modified if the user to whom the task was originally assigned decides to drop-out/decline/postpone.

### 9.6 CONCLUSION

In the previous sections a novel system for optimized time allocation of personal tasks has been presented. Its innovative features include intelligent, optimized and automated scheduling of the user-specified tasks, which include a number of constraints, priorities and preferences. Furthermore, the proposed system is designed to quickly adapt the task schedule in response to the dynamically changing constraints. Fast task schedule optimization and adaption is made possible by efficient utilization of the system computing resources which comprise of both end user's smartphone device and the supporting cloud computing infrastructure. Further characteristics of the presented optimized personal scheduling system include interoperability with multiple calendar systems, capability to learn user priorities and preferences, intelligent utilization of location information, customizable user interface allowing different interaction models, privacy protection and security of user data, scheduling of joint tasks among multiple system users. The presented scheduling system may be expanded to e.g. interact with customer relationship management systems (for corporate users), or include data generated by location-aware online buyer advisors (for consumer users).

### Claims

1. A mobile phone application which includes a system and a method to automatically schedule tasks from a dynamically changing task list for efficient utilization of available time.
2. A method of claim 1 further including optimization algorithms and computer programs which automatically create a time schedule of tasks
3. A system and method of claim 1 which further allows the user of the application to specify multiple constraints related to the tasks and automatically takes into account those constraints when scheduling the tasks. The constraints include individual task's deadline, start time, minimum and maximum time-chunks for task fragments, and relative priority of tasks.
4. A system and method of claim 1 which further allows the user of the application to specify multiple preferences regarding an individual task or a group of tasks, including time-of-day, location, or difficulty of the tasks.
5. A system and method of claim 1 which further automatically considers single or multiple user's calendar information, and regards time slots scheduled in the calendars as unavailable for task scheduling.
6. A system and method of claim 1 which further considers as unavailable for task scheduling the time periods specified by the user.
7. A system and method of claim 1 which further automatically reprioritizes tasks according to the user input, and updates the task schedule adaptively and automatically when new tasks are added, and when constraints or preferences for the existing tasks are altered by the user.
8. A system and method of claim 1 which further uses computational resources of both the mobile phone device and the cloud computing (server) infrastructure when automatically generating an optimized time schedule for the specified tasks
9. A system and method of claim 1 which further operates in a networked mode in which joint tasks involving multiple users and their calendars, constraints and preferences are automatically scheduled.

### REFERENCES

The following are incorporated herein by reference:

### REFERENCES

[1] Goleman Daniel, Focus: The Hidden Driver of Excellence, Harper, 2013.
[2] Wikipedia, Pomodoro Technique—Wikipedia, The Free Encyclopedia, http://en.wikipedia.org/wiki/Pomodoro_Technique (accessed May 12, 2013).
[3] Boyd, Stephen P., and Lieven Vandenberghe, Convex optimization. Cambridge university press, 2004.
[4] Schrijver, Alexander, Theory of linear and integer programming, John Wiley & Sons, 1998.
[5] Evans, James, Optimization algorithms for networks and graphs, CRC Press, 1992.
[6] Papadirnitriou, Christos H., and Kenneth Steiglitz, Combinatorial optimization: algorithms and complexity, Courier Dover Publications, 1998.

What is claimed:

1. A method of suggesting optimal execution times for tasks to be assigned to an individual or a group of individuals (henceforth called assignee) comprising:
receiving task description and task attributes;
receiving available times of the assignee for performing such tasks;
receiving one or more event calendars of the assignee;
receiving habitual unavailable times of the assignee;
providing optimal schedule of tasks, if feasible;
providing targeted advertisement based on task description.

2. The method of claim 1 further comprising at least one task to be performed.

3. The method of claim 1 further comprising at least one potential assignee for the one task.

4. The method of claim 1 further comprising at least one unavailable time period of assignee.

5. The method of claim 4 further comprising at least one calendar belonging to each assignee; events in said calendar have occurrence times which are invariant with respect to the coordinated universal time (UTC).

6. The method of claim 4 further comprising at least one habitual event of at least one assignee; occurrence times of said event are relative to time-zone of assignee's location.

7. The method of claim 1 further comprising at least one attribute of the one task.

8. The method of claim 7 wherein one attribute is a start date and time.

9. The method of claim 7 wherein one attribute is a stop date and time.

10. The method of claim 7 wherein one attribute is an estimated time for the said task to require to be accomplished by assignee.

11. The method of claim 7 wherein one task-portion is an upper-limit on the amount of time the assignee wishes to spend on said task continuously.

12. The method of claim 7 wherein one task-portion is a lower-limit on the amount of time the assignee wishes to spend on said task continuously.

13. The method of claim 7 further comprising at least one preference.

14. The method of claim 13 wherein one preference is at least one location preference.

15. The method of claim 13 wherein one preference is at least one time-of-day specification.

16. The method of claim 13 wherein one preference is at least one day-of-week specification.

17. The method of claim 7 further comprising at least one priority.

18. The method of claim 7 further comprising at least one assignee.

19. The method of claim 18 wherein assignee is one self.

20. The method of claim 18 wherein assignee is more than one individual.

21. The method of claim 1 further comprising at least one optimal scheduling algorithm.

22. The method of claim 21 further comprising using machine-learning algorithm to learn assignee's geographic location patterns over some time and using said learned information to predict assignee's future location in order to schedule assignee's tasks at a future time.

23. The method of claim 21 further comprising goal function used to optimize schedule of tasks and to measure optimality of said schedule of tasks.

24. The method of claim 21 further comprising on-the-fly task scheduling based on change in received information.

25. The method of claim 24 wherein one received information is change of assignee's geographic location.

26. The method of claim 24 wherein one received information is change of assignee's pre-existing calendar events' time attributes.

27. The method of claim 24 wherein one received information is addition of at least one new event to at least one calendar of assignee.

28. The method of claim 24 wherein one received information is deletion of at least one pre-existing event from at least one calendar of assignee.

29. The method of claim 24 wherein one received information is a change of at least one habitual unavailability of assignee.

30. The method of claim 1 further comprising a method for infeasibility handling.

31. The method of claim 30 further comprising a method for identifying infeasibility of scheduling the tasks based on available time and task attributes.

32. The method of claim 30 further comprising a method for suggesting task attribute change.

33. The method of claim 30 further comprising a method for suggesting habitual event parameter change.

34. The method of claim 1 further comprising a method for delegating a task to a different assignee.

35. The method of claim 1 further comprising targeted advertising based on natural-language-processing of task description.

36. A non-transitory computer-readable medium storing computer-executable instructions that, when executed by a processing unit, cause the processing unit to implement a method of suggesting optimal execution times for tasks to be assigned to an individual or a group of individuals (henceforth called assignee), by performing the steps of:
receiving task description and task attributes;
receiving available times of the assignee for performing such tasks;
receiving one or more event calendars of the assignee;
receiving habitual unavailable times of the assignee;
providing optimal schedule of tasks, if feasible;
providing targeted advertisement based on task description.

37. The non-transitory computer-readable medium of claim 36 further comprising at least one task to be performed.

38. The non-transitory computer-readable medium of claim 36 further comprising at least one potential assignee for the one task.

39. The non-transitory computer-readable medium of claim 36 further comprising at least one unavailable time period of assignee.

40. The non-transitory computer-readable medium of claim 39 further comprising at least one calendar belonging to each assignee; events in said calendar have occurrence times which are invariant with respect to the coordinated universal time (UTC).

41. The non-transitory computer-readable medium of claim 39 further comprising at least one habitual event of at least one assignee; occurrence times of said event are relative to time-zone of assignee's location.

42. The non-transitory computer-readable medium of claim 36 further comprising at least one attribute of the one task.

43. The non-transitory computer-readable medium of claim 42 wherein one attribute is a start date and time.

44. The non-transitory computer-readable medium of claim 42 wherein one attribute is a stop date and time.

45. The non-transitory computer-readable medium of claim 42 wherein one attribute is an estimated time for the said task to require to be accomplished by assignee.

46. The non-transitory computer-readable medium of claim 42 wherein one task-portion is an upper-limit on the amount of time the assignee wishes to spend on said task continuously.

47. The non-transitory computer-readable medium of claim 42 wherein one task-portion is a lower-limit on the amount of time the assignee wishes to spend on said task continuously.

48. The non-transitory computer-readable medium of claim 42 further comprising at least one preference.

49. The non-transitory computer-readable medium of claim 48 wherein one preference is at least one location preference.

50. The non-transitory computer-readable medium of claim 48 wherein one preference is at least one time-of-day specification.

51. The non-transitory computer-readable medium of claim 48 wherein one preference is at least one day-of-week specification.

52. The non-transitory computer-readable medium of claim 42 further comprising at least one priority.

53. The non-transitory computer-readable medium of claim 42 further comprising at least one assignee.

54. The non-transitory computer-readable medium of claim 53 wherein assignee is one self.

55. The non-transitory computer-readable medium of claim 53 wherein assignee is more than one individual.

56. The non-transitory computer-readable medium of claim 36 further comprising at least one optimal scheduling algorithm.

57. The non-transitory computer-readable medium of claim 56 further comprising using machine-learning algorithm to learn assignee's geographic location patterns over some time and using said learned information to predict assignee's future location in order to schedule assignee's tasks at a future time.

58. The non-transitory computer-readable medium of claim 56 further comprising goal function used to optimize schedule of tasks and to measure optimality of said schedule of tasks.

59. The non-transitory computer-readable medium of claim 56 further comprising on-the-fly task scheduling based on change in received information.

60. The non-transitory computer-readable medium of claim 59 wherein one received information is change of assignee's geographic location.

61. The non-transitory computer-readable medium of claim 59 wherein one received information is change of assignee's pre-existing calendar events' time attributes.

62. The non-transitory computer-readable medium of claim 59 wherein one received information is addition of at least one new event to at least one calendar of assignee.

63. The non-transitory computer-readable medium of claim 59 wherein one received information is deletion of at least one pre-existing event from at least one calendar of assignee.

64. The non-transitory computer-readable medium of claim 59 wherein one received information is a change of at least one habitual unavailability of assignee.

65. The non-transitory computer-readable medium of claim 36 further comprising a method for infeasibility handling.

66. The non-transitory computer-readable medium of claim 65 further comprising a method for identifying infeasibility of scheduling the tasks based on available time and task attributes.

67. The non-transitory computer-readable medium of claim 65 further comprising a method for suggesting task attribute change.

68. The non-transitory computer-readable medium of claim 65 further comprising a method for suggesting habitual event parameter change.

69. The non-transitory computer-readable medium of claim 36 further comprising a method for delegating a task to a different assignee.

70. The non-transitory computer-readable medium of claim 36 further comprising targeted advertising based on natural-language-processing of task description.

71. A computing device comprising: a data bus; a memory coupled to the data bus; one or more processing units coupled to the data bus and configured to:
receive task description and task attributes;
receive available times of the assignee for performing such tasks;
receive one or more event calendars of the assignee;
receive habitual unavailable times of the assignee;
provide optimal schedule of tasks, if feasible;
provide targeted advertisement based on task description.
